(19) United States
(12) Patent Application Publication
(10) Pub. No.: US 2016/0012664 A1
(43) Pub. Date: Jan. 14, 2016

(54) PLAYER MONITOR

(71) Applicant: Sina Sotoodeh, Reno, NV (US)

(72) Inventor: Sina Sotoodeh, Reno, NV (US)

(21) Appl. No.: 14/798,450

(22) Filed: Jul. 13, 2015

Related U.S. Application Data
(60) Provisional application No. 62/024,386, filed on Jul. 14, 2014.

(51) Int. Cl. G07F 17/32

(52) U.S. Cl. CPC G07F 17/323; G07F 17/3244

(57) ABSTRACT

A player frequency monitor may be coupled to a gaming device to receive parameters of the player's wagering. If the player's wagering satisfies a threshold requirement, such as amount wagered, rate wagered, amount of losses etc, the player may qualify for a gratuity such as a free drink. The player's qualification for free service may be discretely displayed on a light of the gaming cabinetry to be visible to passing drinks attendants or may be displayed to a bartender within a bar area, in particular for table top gaming devices. The player frequency monitor may be retro-fitted to existing gaming machines via a one-way optocoupling that prevents the player frequency monitor from interfering with any meters of the gaming device.

### CROSS REFERENCE TO RELATED APPLICATIONS

This application claims priority to U.S. provisional patent application Ser. No. 62/024,386, filed 14 Jul. 2014, the contents of which are herein incorporated by reference.

### FIELD OF THE INVENTION

The present invention relates to gaming environments and in particular to systems and methods for monitoring and providing player rewards.

### BACKGROUND

It is common for a casino to compensate players with free drinks as the player is playing a slot machine. This practice has been in place for many years and increases the cost to the casino in return for the player to play at the slot machine to generate revenue.

Generally the player will tip the bartender or the drinks attendant when the drink is served while the player is sitting at a slot machine. This practice is not monitored closely to see if the player has funds in the slot machine and is playing. It is up to the bartender/attendant to determine if they can be rewarded with a free drink.

This practice is widely used but can be abused on the casino floor which costs the casino lost revenues and the additional costs of the reward due to the player not playing the slot machine but sitting at the slot machine. Many times they will even deposit funds into the slot machine to appear they are making bets on the slot machine to receive a drink. During very busy times the casino cannot ask its bartender/attendant to monitor if the player is making bets on the slot machine.

This leaves a problem for the casino operator that it serves drinks to non-playing customers who tip the bartender/attendant for the drink at the casino's expense.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to monitor rate of play by a player to determine if a player qualifies for a gratuity, such as a free drink;

the ability to indicate a player's qualification for a free service to a passing attendant or bartender;

the ability to retrofit a gaming device with a player frequency monitor without modification to the hardware or software of the gaming device;

the ability to monitor table top gaming machine use in a bar area.

These and other advantages may be realized by reference to the remaining portions of the specification, claims, and abstract.

### Brief Description of One Embodiment of the Present Invention

In one aspect, the invention provides a player frequency monitor for use with a gaming device in which a player places a wager and plays a game. The player frequency monitor may comprise at least one indicator light and at least one controller. The controller may receive wagering parameters of the gaming device, whether the player qualifies for a gratuity and if so, indicate the player's qualification on the indicator light.

In one aspect, the invention provides a gaming device comprising a player frequency monitor that receives an input of one or more wagering parameters for the gaming device and displays to a bartender whether a player qualifies to receive a service.

In one aspect, the invention provides a player frequency monitor comprising controller means for determining whether a player's amount of play at a gaming device qualifies the player to receive a gratuity and display means for displaying the qualification.

In one aspect, the invention provides a method for providing service to a player of a gaming device. The method may include coupling at least one controller to at least one meter of the gaming device and coupling at least one indicator to the at least one controller. The controller may process input from the at least one meter to the at least one controller to determine if the player qualifies for a gratuity. The player's qualification for a gratuity may be indicated on the indicator.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 substantially depicts a monitoring system in accordance with one embodiment;

FIG. 2 substantially depicts a mobile application system that can be used by drinks attendants to provide service to gaming patrons; and

FIG. 3 substantially depicts a process of a controller of a player frequency monitor.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

In one embodiment, there is provided a player frequency monitoring (PFM) unit that is able to monitor play parameters of a gaming machine and provide an indication, for example by a discrete light unit on the gaming machine, that the play parameters meet a requirement for the player to be served a drink or receive other gratuity, good or service from the gaming operator. The monitoring unit may connect to a slot machine via multiple channels and is programmable at the slot machine or from a remote location. This remote location can be in the casino operations room or offsite location.

The gaming device/slot machine may be any gaming device known in the art that enables a player to place a wager and play a game. Such gaming devices, slot machines, etc. are well known and thus further description of the gaming device is not considered pertinent to the present specification.

The monitoring unit has indicators (e.g. an LED) that provide relatively discrete indication to a passing attendant that the player is betting in a manner that qualifies for a free service, such as a free drink. The player betting may qualify by satisfying a rate (time based or money based), an amount, an amount of losses, or other suitable threshold. The control of the indicator can be changed to determine a minimal play time or bet level, thereby accounting for different busy periods of the gaming establishment. For example, this control can be set for 1 minute to any other time multiple.

The attendant only needs to look for an easily seen indicator to determine if the player is placing bet/play in a timely frequency to be rewarded with a free drink. Additionally, this indicator can be made so the customer playing the slot machine is aware of their playing status and if they qualify for a drink.

The monitoring unit may be set to monitor if the player is playing at a rate above a threshold rate. The threshold rate may be a time based rate, e.g. game cycles per minute, or a money based rate, e.g. credits per minute, or any combination required. This can be tied to any of metering ports of the slot machine. This setting can be set by casino management to help control and offset any costs to offering free rewards and is not dependent on the drinks attendant to make the decision.

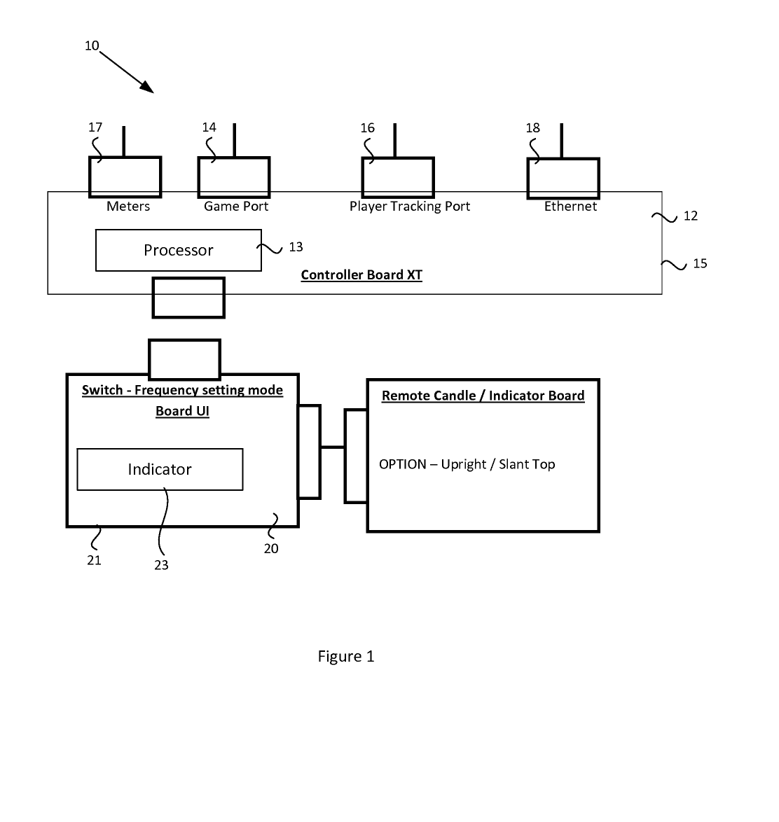

FIG. 1 shows an embodiment of the monitoring unit 10. The monitoring unit may include a controller board 12. The controller board 12 is a circuit board that includes at least one on board processor 13 and associated electronics. The controller board 12 may be provided in its own housing 15 with a series of connection ports provided in the housing for providing communications and power connections to the controller board. The controller board housing 15 may be mounted within the gaming machine cabinet in a location where the connections are easily accessible. The controller board housing 15 may include flanges (not shown) or similar mounting components of the unit to attach mounting screws. As an alternative, the controller unit 12 may be inserted into the gaming machine electronics, if a suitable port, slot or location is available.

The controller board 12 may monitor the slot machine through either the slot machine, or player tracking device, or any device that interfaces to the slot machine including any wireless devices, gaming servers, etc. In one embodiment, the controller board may read a signal off of a port in the gaming device that is used to run a meter, such as an external progressive meter display. The ports can include an SAS interface port 14, Player tracking device 16, or the mechanical/electronic meters 17. Any additional ports can be used such as Ethernet connection 18 from a remote site or a wireless interface. Through any one of these inputs, the controller board 12 receives signals from which the controller board 12 is able to determine, using the on board processor(s), whether the game machine is being played at play parameters that satisfy the threshold requirements for the player to receive a gratuity.

The controller board 12 interfaces with a user interface, such as an indicator board 20 via an output port 19. In one embodiment, the indicator board 20 may be a simple LED indicator located on the outside of the gaming machine cabinet. Alternatively, the indicator board 20 may be a circuit board with an on board processor and associated electronics that receives signals from the controller board 20 and effects a display of the indicator board, which may be a light or sound display, alphanumeric display, screen display, etc. The indicator board 20 may be located within its own housing 21 that may be mounted on the outside of the gaming machine cabinet, on the player tracking device associated with the gaming machine, or some other suitable location that can be conveniently observed by a passing drinks attendant. The user interface may be mounted to a solid area where the connections are accessible and the display is viewable. The UI housing may include a number of flanges on the sides of the unit to attach mounting screws. The indicator board and LED indicator is independent of the functions of the gaming machine in that the LED can display the player's qualification to receive a gratuity such as a free drink. The display of the LED does not affect any game and is not a part of the gaming cycle of the game machine. The LED may thus appear lit through multiple gaming cycles so that it does not matter at what moment in any particular gaming cycle the attendant passes and is able to observe the indicator.

Ribbon cables or the like may be used to provide power and communications to the indicator board 20, e.g. from the controller board 12. In an alternative embodiment, the components may receive power and communications through USB connections. Alternatively, communications can be provided by wireless connections such as Bluetooth or WiFi.

When the rate of game play is above the threshold required, the controller board outputs a control signal to the display to indicate the game play status, e.g. by illuminating the LED 23. A passing drinks attendant is able to observe the display and provide drinks service to the player if appropriate.

For a table top machine (bar areas) a small LED can be placed anywhere behind the bar or next to a game. If the indicator is in the ok mode then the bartender is approved to serve drinks without charging. An advantage for table top machines is that during busy times with other players waiting to sit and play at the bar the bartender can ask the current customer who is not playing to either play or leave to free up the slot machine.

The monitoring unit can be incorporated and connected to a player tracking system and share the same electronics or be a standalone hardware interface. The method of how the indictor is displayed can be done anywhere on the slot machine with this configuration.

Using the Ethernet the monitoring unit can be linked to a server (direct wired or wireless). The server can then push signals to remote indicators. For example, bartenders and drinks servers may reference the remote indicators away from the gaming machines, e.g. in a drinks preparation area, bartender closet area, etc. to view which gaming machines are currently eligible to receive free drinks services. The remote indicators may be associated with a map of the slot floor so that the attendants can quickly reference where to locate the eligible gaming machines.

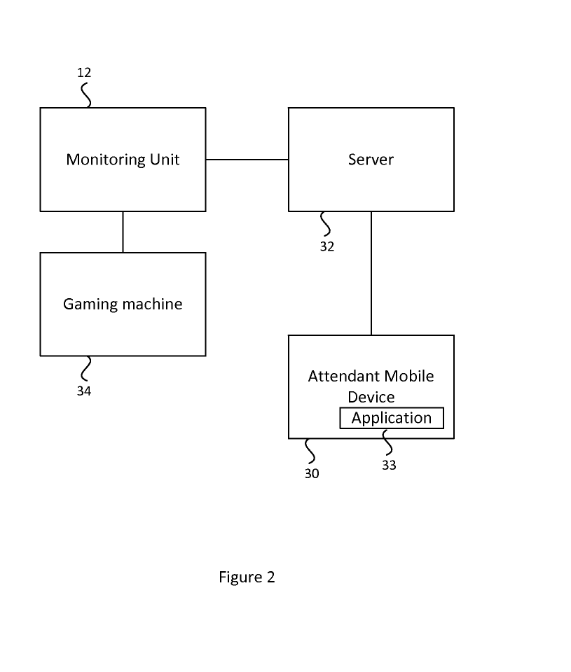

In one embodiment, described with reference to FIG. 2 the drinks attendants may carry a mobile display device 30, such as a mobile phone, that is able to communicate wirelessly with a server 32 operated by the casino. The mobile device 30 may execute an application 33 that assists the drinks attendant in determining when and where to provide drinks service. The server 32, having received an indication from a monitoring unit 12 that the game machine 34 satisfies the play rate threshold, may push a notification to the mobile device 30 to indicate that drinks service at the gaming machine 34 is required. The application 33 on the mobile device 30 receives the notification and indicates that the drinks service is required. The indication may include a map of the casino floor, displayed on the mobile device 30 by the application 33 that shows the location of the gaming machine 34.

Once drinks service has been provided to a gaming machine, a reset command may be provided to the monitoring unit that resets the qualification status of the gaming machine. The rest may be accompanied by a timer that prevents the gaming machine from requalifiying for a free service for a required period. The period may be programmable or static. The reset command may be provided to the monitoring unit via a reset button on the user interface 22, via a short range wireless interface from the drinks attendant, or via a command sent from the server via the Ethernet.

Parameters of the monitoring unit may be programmable to account for different busy periods of the casino, special promotions, etc. The parameters may be programmable by commands received through one or more controls on the user interface, via a short range wireless interface (e.g. Bluetooth) from a casino employee, or via a command sent from the server via the Ethernet.

In one embodiment, the indicator is a small box controlled by electronics that monitor the slot machine through either the slot machine, or player tracking device, or any device that interfaces to the slot machine including any wireless devices. The ports can be the SAS interface port, Player tracking device, or the mechanical/electronic meters. Any additional ports can be used such as an Ethernet connection from a remote site or a wireless interface.

The interface can be through any output device such as LED indicator, candle light, on the display of any device on a slot machine (either slot machine or player tracking device displays). There is no limit on what type of device this can be put on, including an app for a cell phone for the use of the bartender/server or customer.

For a table top machine (bar areas) a small LED can be placed anywhere behind the bar or next to a game. If the indicator is in the ok mode then the bartender is approved to serve without charging. Another benefit is that during busy times with other players waiting to sit and play at the bar, the bartender can ask the current customer who is not playing to either play or leave to free up the slot machine. This is otherwise a problem due to the limited bar playing areas in a casino and can be very difficult to manage. In such a bar environment, a panel of multiple indicators may be provided within view of the bartender or the indicators may be provided in individual areas for each gaming machine. The controllers may be mounted within each table top machine or a cabinet of multiple controllers may be provided within a centralized area with individual connections to each of the table top gaming devices. The communications from the controllers to the gaming devices may be direct cables, e.g. ribbon cables, or by wireless or WiFi systems such as Bluetooth.

For other upright machines or slant top machines on the floor the indicator can be an additional light placed on the candle or small LED placed on the outside of the slot machine.

This invention can be incorporated and connected to a player tracking system and share the same electronic or be a standalone hardware interface. The method of how the indictor is displayed can be done anywhere on the slot machine with this configuration.

Although not necessary, the controller unit (XT) may be mounted to a solid area inside the gaming machine cabinet where the connections are easily accessible. The XT housing includes flanges on the sides of the unit to attach mounting screws. The PFM XT is a single-board embedded 8-bit microcontroller based system. The base configuration has one opto-coupled transistor port, one serial port (used for debug) and a parallel LED driver/switch input to/from the PFM UI assembly.

A two-wire harness is used to connect the PFM XT to the gaming machines' COIN IN/CREDITS PLAYED internal hard-meter. The hardware on the PFM XT consists of an optocoupler for this connection. This allows a one-way, galvanic isolation which prevents any possibility of manipulating the gaming machines' meter.

The PFM contains a 256-byte EEPROM area used for storing the user settings. One configuration of the memory may include 5-bytes of this area used for these settings and may be defined as:

Byte0—Key, tells the firmware that the data contained is invalid or valid. An invalid, unprogrammed value is 0xFF whereas when the data is valid contains ‘F’ (0x46).

Byte1—Denomination, tells the firmware what value each meter tick is worth. The possible values are 01, 05, 10, 25 and 100 as a US currency “cents” value.

Byte2—Trip Amount, tells the firmware what value is considered a successful amount for a given session. The possible values are 01, 02, 05, 10, 20 and 50 as a US currency “dollars” value.

Byte3—Time Frame, tells the firmware what value is considered a time limit for a given session. The possible values are 01, 02, 05, 10, 20 and 30 as a “minutes” value.

Byte4—Safety Time, tells the firmware what value is considered a time limit for a given successful session. The possible values are 01, 02, 05, 10, 20, 30 and 60 as a “minutes” value.

The PFM XT utilizes a 2-digit, 7-segment display module which acts a visual interface to the user. This display is buffered from the microcontroller through (2) BCD display drivers. This allows the user to enter the specific settings as discussed herein.

The PFM UI simply uses a bi-color illuminated SPDT switch mounted in a housing for easy mounting. This allows visual indication as well as the RESET feature for the casino employee. The user interface (UI) can be mounted to a solid area where the ribbon cable connection is accessible and the display is viewable. In some embodiments, the UI housing may includes flanges on the sides of the unit to attach mounting screws for mounting to cabinetry of the gaming machine. In other embodiments, e.g. for bar environments, the UI may be mounted somewhere discretely so that a bartender is able to view the UI.

The PFM may include a timer. When the play conditions have been met and the LED indicator is set green, the PFM XT sets a safety timer. If the user/attendant does not depress the RESET switch within a timeout period of the safety timer, the PFM XT will automatically cancel the met condition, reset variables to zero and set the LED back to red. The setting for the safety timer is configurable.

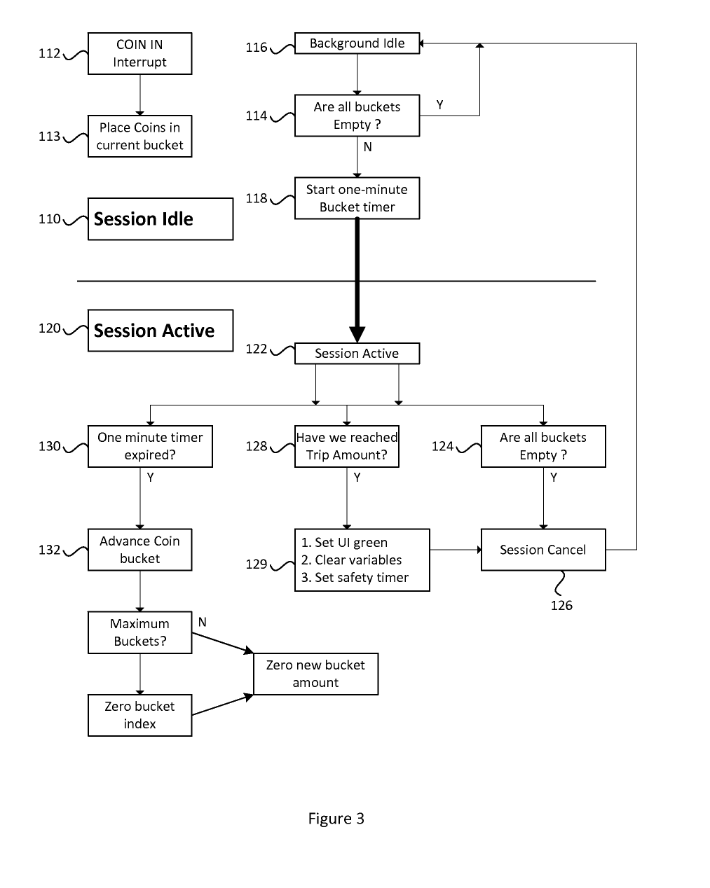

FIG. 3 shows an embodiment of the software processes that may execute on the XT controller. The software processes can be divided into two main states.

A. Session Idle 110, no coin meter activity from gaming machine; and

B. Session Active 120, there has been meter activity.

In the session idle state 110, the software constantly checks the status of the coin buckets 114. If the buckets are empty, i.e. no activity, then the process loops back to idle 116. When a Coin interrupt event occurs, 112, the coin buckets are advanced 113 so that at next check 114, the process starts the bucket timer 118 and advances to the Session Active state 122.

In the Active session, the XT controller runs a timer 130 and advances the coin ‘buckets’ when needed 132 and determines the status of the buckets, monitoring for two conditions:

C. all the buckets have been checked and no activity has taken place 124. This is indicative of an idle gaming machine not being played so cancel any active session 126 and return to background idle 116.

D the monetary condition outlined by the PFM configuration settings 128 has been met, in which case 129, notify the casino employee by illuminating the LED green, clear the variables and cancel the active session.

An advantage of the monitoring unit herein described includes that it is able to monitor the real time status of play on a slot machine to reward the player based on play or bet minimums. A further advantage is that the eligibility for reward can be conveniently displayed to passing drinks attendants.

The player frequency monitor can be retrofitted to many pre-existing gaming machines and does not typically require modification of the hardware or software of the gaming device.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A player frequency monitor for use with a gaming device in which a player places a wager and plays a game, the player frequency monitor comprising:
(A) at least one indicator light; and
(B) at least one controller comprising:
(a) at least one port that receives an input of one or more wagering parameters by a player at the gaming device; and
(b) at least one processor programmed to:
(i) determine from the input whether the player qualifies for a gratuity; and
(ii) when it is determined that the player qualifies for a gratuity, indicate the qualification via the at least one indicator light.

2. The player frequency monitor of claim 1 wherein the at least one port comprises an interface to a credit meter of the gaming device.

3. The player frequency monitor of claim 1 wherein the at least one port comprises an interface to an external meter port of the gaming device.

4. The player frequency monitor of claim 1 wherein the at least one port comprises at least one opto-coupled transistor port that prevents manipulation of any meters of the gaming device.

5. The player frequency monitor of claim 1 wherein the at least one indicator light comprises a light disposed on cabinetry of the gaming device.

6. The player frequency monitor of claim 1 wherein the controller is programmed to display the qualification through multiple gaming cycles of the gaming device.

7. The player frequency monitor of claim 1 comprising a reset button that is operable by an attendant of the gaming device.

8. The player frequency monitor of claim 1 comprising a housing for the controller that can be retrofitted to the gaming device.

9. The player frequency monitor of claim 1 wherein the controller is programmed to communicate the qualification to at least one of a server or a mobile application of an attendant.

10. A gaming device comprising a player frequency monitor comprising:
(A) at least one port that receives an input of one or more wagering parameters for the gaming device; and
(B) at least one processor programmed to:
(a) process the input; and
(b) display the processed input on a display visible to a bartender.

11. The gaming device of claim 10 wherein the processor is programmed to determine if the player qualifies for a gratuity and display the qualification to the bartender on the display.

12. The gaming device of claim 11 further comprising a reset switch operable by the bartender for resetting the qualification.

13. The gaming device of claim 10 wherein the processor is programmed to display a rate of play at the gaming device to the bartender on the display.

14. The gaming device of claim 10 wherein the at least one port comprises at least one opto-coupled transistor port that prevents manipulation of any meters of the gaming device.

15. A player frequency monitor comprising:
(A) controller means for determining whether a player's amount of play at a gaming device qualifies the player to receive a gratuity; and
(B) display means for displaying the qualification.

16. The player frequency monitor of claim 15 comprising mounting means for retro-mounting the player frequency monitor within a cabinet of the gaming device.

17. The player frequency monitor of claim 15 comprising coupling means for coupling the controller to at least one meter of the gaming device.

18. The player frequency monitor of claim 17 wherein the coupling means prevents manipulation of any meters of the gaming device by the player frequency monitor.

19. A method for providing service to a player of a gaming device comprising:
(A) coupling at least one controller to at least one meter of the gaming device;
(B) coupling at least one indicator to the at least one controller;
(C) processing an input from the at least one meter to the at least one controller to determine if the player qualifies for a gratuity; and
(D) indicating if the player qualifies for a gratuity on the at least one indicator.

20. The method of claim 19 wherein coupling the at least one controller to the at least one meter comprises preventing the at least one controller from interfering with the at least one meter.

21. The method of claim 19 comprising mounting at least one indicator on external cabinetry of the gaming device.

22. The method of claim 19 comprising mounting the at least one controller within cabinetry of the gaming device.
